(19) United States
(12) Patent Application Publication
(10) Pub. No.: US 2025/0356245 A1
(43) Pub. Date: Nov. 20, 2025

(54) QUANTIZATION-AWARE TRAINING FOR MACHINE LEARNING MODEL ADAPTERS

(71) Applicant: QUALCOMM Incorporated, San Diego, CA (US)

(72) Inventors: Yelysei BONDARENKO, Amsterdam (NL); Markus NAGEL, Amsterdam (NL); Riccardo DEL CHIARO, Amsterdam (NL)

(21) Appl. No.: 18/664,531

(22) Filed: May 15, 2024

(51) Int. Cl. G06N 20/00

(52) U.S. Cl. CPC G06N 20/00

(57) ABSTRACT

Certain aspects of the present disclosure provide techniques and apparatus for improved machine learning. In an example method, a first plurality of weights for a base model and a second plurality of weights for an adapter model associated with the base model are accessed. A quantized plurality of weights is generated based on the first plurality of weights, a first quantization scale for the first plurality of weights, and the second plurality of weights. A loss is generated based on processing training data using the quantized plurality of weights. An updated second plurality of weights is generated based on updating the second plurality of weights based on the loss. A machine learning model comprising quantized versions of the first plurality of weights and the updated second plurality of weights is deployed.

### INTRODUCTION

Aspects of the present disclosure relate to machine learning.

A wide variety of machine learning model architectures have been trained to perform an assortment of diverse tasks, including computer vision tasks, language tasks, classification and regression tasks, and the like. Recently, research has yielded substantial success in using large language models (LLMs) and/or large vison models (LVMs) to process and generate output data. Often, machine learning models (especially LLMs and LVMs) have many parameters (e.g., millions or even billions), resulting in significant model size, as well as substantial computational expense in training the model. Further, once trained, such models are often difficult (or impossible) to fine-tune, as the vast number of parameters makes overfitting a major challenge (e.g., potentially relying on tremendous amounts of fine-tuning data to prevent overfitting). One recent approach to enable fine-tuning or personalization of such generative models involves training relatively smaller model adapters for larger models.

Further, some efforts to enable more use of machine learning models with reduced computational expense involve model quantization. Several approaches to quantization have been proposed, but each has shortcomings. For example, post-training quantization can effectively reduce model size, but often results in substantially reduced model accuracy. Quantization-aware training can help preserve model accuracy, but introduces substantial additional cost during training.

### BRIEF SUMMARY

Certain aspects of the present disclosure provide a processor-implemented method, comprising: accessing a first plurality of weights for a base model; accessing a second plurality of weights for an adapter model associated with the base model; generating a quantized plurality of weights based on the first plurality of weights, a first quantization scale for the first plurality of weights, and the second plurality of weights; generating a loss based on processing training data using the quantized plurality of weights; generating an updated second plurality of weights based on updating the second plurality of weights based on the loss; and deploying a machine learning model comprising quantized versions of the first plurality of weights and the updated second plurality of weights.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict certain aspects of the present disclosure and are therefore not to be considered limiting of the scope of this disclosure.

FIG. 1 depicts an example workflow for quantization-aware training of machine learning models, according to some aspects of the present disclosure.

FIG. 2 depicts an example architecture for quantization-aware training of machine learning model adapters, according to some aspects of the present disclosure.

FIG. 3 depicts example architectures for efficient parameter storage for quantization-aware training, according to some aspects of the present disclosure.

FIG. 4 is a flow diagram depicting an example method for quantization-aware training of model adapters, according to some aspects of the present disclosure.

FIG. 5 is a flow diagram depicting an example method for quantizing model parameters for quantization-aware training, according to some aspects of the present disclosure.

FIG. 6 is a flow diagram depicting an example method for quantization-aware training, according to some aspects of the present disclosure.

FIG. 7 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and non-transitory computer-readable mediums for providing improved machine learning.

In some aspects of the present disclosure, a hybrid combination of post-training quantization (PTQ) and quantization-aware training (QAT) can be utilized to enable significantly more efficient training with a relatively small amount of overhead while further retaining substantial benefits of quantization without additional overhead during inference.

Generally, PTQ is relatively fast and efficient to apply, but often leads to unsatisfactory model accuracy and/or perplexity, especially when using lower weight bitwidths (e.g., four bits per weight). QAT often yields significantly better model accuracy, but there are several challenges that make it impractical to use QAT for large models (e.g., LLMs and LVMs). For example, some conventional QAT approaches can introduce substantial memory overhead due to the reliance on stored shadow weights (and the gradients for the shadows weights) as well as the optimizer state for the shadow weights in thirty-two bit floating-point representation. As a result, some conventional QAT approaches cannot be used on many common devices (e.g., desktop computers with a single graphics processing unit (GPU)). Further, some conventional approaches to QAT carry a risk of model overfitting, potentially relying on manual tuning of the regularization hyperparameters. QAT also introduces compute overhead for simulated quantization, resulting in extra compute resources consumed during both the forward and the backward passes.

Low-rank adaptation (LoRA) for large models (e.g., LLMs) was initially designed for task-specific fine-tuning of such models. Generally, LoRA relies on using model adapters with relatively few parameters, as compared to the base model itself. This enables substantially reduced computational expense to train and refine, as compared to full fine-tuning of the base model.

In some aspects of the present disclosure, PTQ, QAT, and LoRA adapters are combined to enable substantially more efficient training, fine-tuning, and inference, as compared to some conventional approaches. In some aspects, PTQ can be used to quantize a pre-trained base model, and QAT can be used to refine the model adapters such that these low-rank adapters are made aware of the quantization grid of the base model during training. In some aspects of the present disclosure, therefore, the models can be trained significantly faster and with substantially less memory overhead, as compared to traditional QAT.

### Example Workflow for Quantization-Aware Training of Machine Learning Models

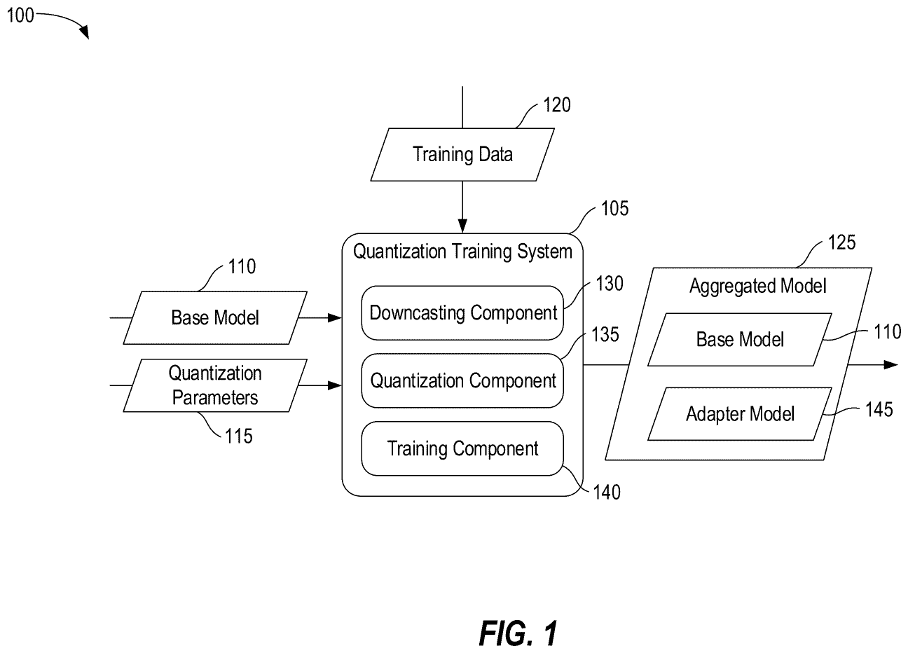

FIG. 1 depicts an example workflow 100 for quantization-aware training of machine learning models, according to some aspects of the present disclosure.

In the illustrated workflow 100, a quantization training system 105 accesses a base model 110 and a corresponding set of quantization parameters 115, as well as a set of training data 120, and generates an aggregated model 125. As used herein, “accessing” data can generally include receiving, requesting, retrieving, generating, collecting, obtaining, or otherwise gaining access to the data. For example, the quantization training system 105 may receive the base model 110 and quantization parameters 115 from another system that trained and quantized the base model 110, or the quantization training system 105 may itself train and quantize the base model 110. Although illustrated as a single discrete system for conceptual clarity, in some aspects, the operations of the quantization training system 105 may be performed by any number and variety of computing systems.

The base model 110 is generally representative of a machine learning model trained to perform any desired task. In some aspects, the base model 110 is referred to as a pre-trained model to indicate that the parameters of the base model 110 are learned during a corresponding training phase (either by the quantization training system 105 or by another system) and then remain frozen or static during the (remainder of) workflow 100. For example, a training system may train the base model 110 and generate the quantization parameters 115, then provide the base model 110 and quantization parameters 115 to the quantization training system 105. In some aspects, the base model 110 is a generative model, such as an LLM, an LVM, and the like. In some aspects, the base model 110 may be referred to as a large model to indicate that the base model has more parameters (and, in some cases, substantially more parameters) than the adapter model(s) discussed in more detail below.

The quantization parameters 115 generally indicate the quantization scheme used to quantize the base model 110. In some aspects, the base model 110 is processed using PTQ (e.g., by the system that trained the base model 110 or by another system) to generate the quantization parameters 115. That is, the quantization parameters 115 may be generated or determined after the base model 110 is trained. In some aspects, the base model 110 may be trained using QAT, and the quantization parameters 115 may be determined during the training of the base model 110. Generally, the quantization parameters 115 can include any information used to indicate the quantization encoding of the base model 110, such as a quantization scale of the base model 110, a zero-point of the base model 110, and the like.

In the illustrated example, the training data 120 may represent the data that is used to train, refine, fine-tune, or otherwise update a set of one or more adapter model(s) for the base model 110. Generally, the particular contents and format of the training data 120 may vary depending on the particular task and implementation. For example, for an LLM, the training data 120 may include textual data (e.g., input prompts and target output strings) in natural language. In some aspects, the training data 120 corresponds to data for a particular user (e.g., to personalize the base model 110 for the specific user). In some aspects, the training data 120 corresponds to data for a specific domain or task (e.g., to specialize the base model 110 for the given domain or task). Generally, as the adapters may be substantially smaller than the base model 110, a relatively small amount of training data 120 can be effectively used to fine-tune the models.

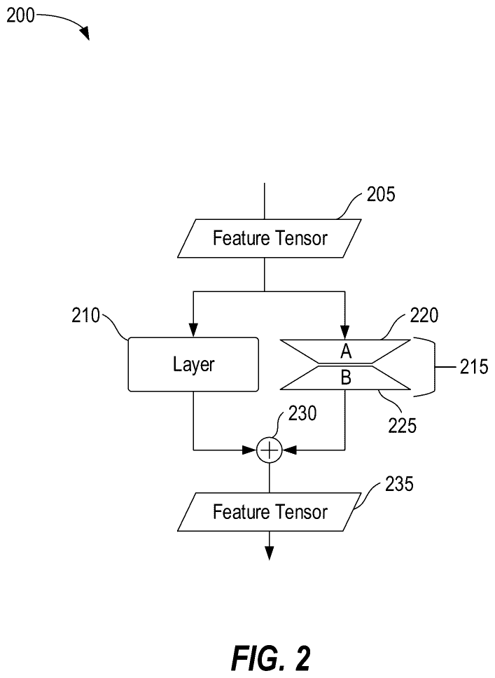

As illustrated, the aggregated model 125 comprises the base model 110 (which may be quantized in accordance with the quantization parameters 115) and at least one adapter model 145 (which may also be quantized in accordance with the QAT process discussed in more detail below). In some aspects, the adapter model 145 can include one or more adapters (e.g., LoRA adapters) used to modify the output of the base model 110. For example, each layer, block, or other component of the base model 110 may have a corresponding set of zero or more adapters in the adapter model 145, where the output of the adapter(s) is used to modify the output of the corresponding portion of the base model 110. One example architecture for the aggregated model 125 is discussed in more detail below with reference to FIG. 2.

In the illustrated workflow 100, the quantization training system 105 includes a downcasting component 130, a quantization component 135, and a training component 140. Though illustrated as discrete components for conceptual clarity, the operations of the depicted components (and others not illustrated) may be combined or distributed across any number of components, and may be implemented using hardware, software, or a combination of hardware and software.

In some aspects, the downcasting component 130 is used to downcast the parameters of the aggregated model 125 (e.g., the base model 110 and/or the adapter model 145) during training to enable more efficient storage (e.g., reduced memory overhead) during training of the adapter model 145, as discussed in more detail below. As used herein, downcasting the parameters may generally include reducing the bitwidth used to store the parameters (e.g., converting the parameters to a data structure or format that can be stored in lower bitwidths). For example, the downcasting component 130 may downcast the parameters from thirty-two-bit floating point (FP32) to a smaller bitwidth such as sixteen-bit brain floating point (BF16), 8-bit integer (INT8), 4-bit integer (INT4), and the like, as discussed in more detail below. This downcasting can reduce memory overhead during training.

The quantization component 135 may be used to quantize the parameters during QAT of the adapter model 145, as discussed in more detail below. In some aspects, this quantization is performed based at least in part on the quantization parameters 115 of the base model 110, such that the adapter model 145 is trained with knowledge of the quantization scheme used for the base model 110. This can substantially improve the accuracy of the aggregated model 125.

In some aspects, the training component 140 generally manages the updating of the parameters of the adapter model 145 during QAT. For example, the training component 140 may use the training data 120 to iteratively update the parameters of the adapter model 145 (e.g., using backpropagation) while maintaining the parameters of the base model 110 fixed and unchanged (e.g., frozen). Generally, the particular operations used to train the adapter model 145 may vary depending on the particular implementation. For example, in some aspects, the training component 140 may process a sample of training data 120 using the aggregated model 125 (e.g., the base model 110 and corresponding adapter model 145) to generate an output, and this output can be compared against a label of the training sample to generate a loss. The training component 140 may then use the loss to update the parameters of the adapter model 145, such as via backpropagation, as discussed in more detail below.

In some aspects, the quantization training system 105 can use a b-bit symmetric uniform affine weight quantization, where b is the desired bitwidth of the parameters of the (quantized) aggregated model 125. In some aspects, b is a hyperparameter. In some aspects, during training of the adapter model 145, the quantization training system 105 can represent the parameters of the aggregated model 125 using Equation 1 below. In Equation 1, Ŵ represents the parameters of the aggregated model 125, s is a quantization scale (which may be a trainable parameter, or may be frozen), φ is a downcasting operation, W is the parameters of the base model 110 (e.g., in original full precision, such as sixteen-bit or thirty-two-bit floating point), s₀ is the quantization scale of the base model 110 (e.g., indicated in the quantization parameters 115), and A and B are the trainable parameters of the adapter model 145.

$$\hat{W} = s * clip ( round ( φ ( \frac{W}{{s}_{0}} ) + AB ) , - {2}^{b - 1} , {2}^{b - 1} - 1 ) \qquad ( 1 )$$

That is, using Equation 1, the quantization training system 105 may scale the (frozen) parameters W of the base model 110 using the initial (frozen) quantization scale s₀, downcast the scaled base model 110 using φ, aggregate (e.g., concatenate) the downcast base model 110 with the parameters A and B of the adapter model 145, round the aggregated parameters to the nearest integer using round (⋅), clip the rounded parameters to values between −2^{b-1} and 2^{b-1}−1 using clip (⋅), and finally scale the clipped parameters using s (which may be learned during training, or may be fixed).

In some aspects, s may be initially set to equal s₀, and may either remain fixed at this value or may be updated during training. In some aspects, s is the scale used to de-quantize the weights during training. That is, in some aspects, the quantization training system 105 may use simulated quantization during training, and may therefore de-quantize the weights during the training (to enable QAT). In some aspects, the quantization training system 105 may normally use s₀ for this process. However, in some aspects, the quantization training system 105 may additionally learn this dequantization parameter s rather than simply using the original s₀. During inference, simulated quantization is not used and the quantization training system 105 (or inferencing system) may instead directly process input data using integer weights for the model (e.g., the quantized model) without dequantizing, and s may therefore be unused. In some aspects, the integer representation of the weights may be precomputed (e.g., W_{Z} in Equation 3, below). The quantized version of these integer weights may therefore be represented as W_{Z}*s. However, because model operations (e.g., matrix multiplication, convolution, and the like) allow for this scale s to be pulled outside of the matrix multiplication (or other operation), the quantized version of W_{Z} may not be explicitly computed during inference. Instead, the scale s (along with a scale of the activation data, if applicable) may be multiplied with the output of the matrix multiplication (or other operation) during inference.

In some aspects, as discussed above, the downcasting operation φ may be implemented in a variety of ways. For example, in some aspects, φ is an identity operation (e.g., the weights are not downcast). In some aspects, φ(x)=BF16 (x) (e.g., the weights are converted to BF16). In some aspects, the downcasting operation is defined using Equation 2 below.

$$φ ( x ) = clip ( round ( x ) , - {2}^{b - 1} , {2}^{b - 1} - 1 ) \qquad ( 2 )$$

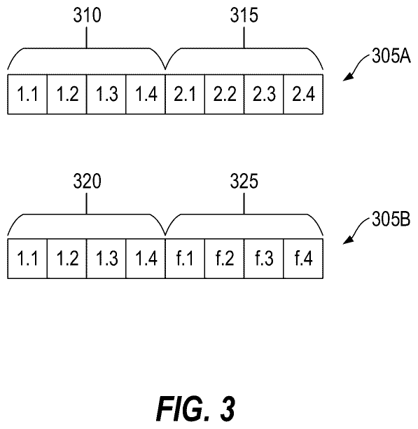

That is, using Equation 2, the downcasting operation may comprise representing the parameters as INT-b. In some aspects, if b is less than or equal to four, the quantization training system 105 may double pack the parameters into INT8 data structures (as some systems lack hardware to efficiently support INT4 formats). That is, the quantization training system 105 may store one parameter in a first portion of an INT8 format (e.g., the first four bits) and store a second parameter in the second portion (e.g., the second four bits). This can substantially improve memory density and reduce overhead. One example approach for double packing the downcast parameters is discussed in more detail below with reference to FIG. 3.

In some aspects, in addition to or instead of double packing the parameters, the quantization training system 105 may store the b bits of each parameter in an INT8 structure, and then use the remaining bits (if any) to approximate the fractional part of the parameter. For example, in the case of b=4, the quantization training system 105 may use the first four bits of an INT8 format to store the parameter, and the remaining four bits may be used to store a fractional part of the parameter created by the downcasting operation (e.g., the fraction removed by the rounding operation in Equation 2). This can allow the quantization training system 105 to retain more precision than 4-bit parameters would otherwise allow.

In some aspects, during training, the parameters A and B of the adapter model 145 are learned within the clipping and rounding operations and based in part on the value of the parameters W of the base model 110 (as well as the scale s₀). That is, during the forward pass, A and B may be rounded to valid integers (e.g., integers that are within the integer or quantization grid defined by the quantization parameters 115). This ensures that the QAT process proceeds with awareness of the quantization used for the base model 110, which can substantially improve model accuracy.

In some aspects, because the base model 110 and the quantization parameters

$$115 ( e . g . , \frac{W}{{s}_{0}} )$$

are frozen during training of the adapter model 145, the quantization training system 105 need not compute gradients for these components, nor does the quantization training system 105 compute first or second-order momentum terms (e.g., for Adams-based optimizers). That is, by only training A, B, and (potentially) s, the number of parameters that the quantization training system 105 computes is substantially reduced.

Further, as discussed above,

$$φ ( \frac{W}{{s}_{0}} )$$

may be stored in relatively small bitwidths (e.g., INT8, or double packing two INT4 parameters into each INT8 structure), further reducing memory overhead. In some aspects, to further reduce memory overhead (which may allow for increased batch size and/or increased training speed with reduced computational resources), the quantization training system 105 may use a checkpointing operation for the quantization function.

For example, during each forward pass, the quantization training system 105 may checkpoint some or all of the intermediate results (e.g., activations and/or parameters of the aggregated model 125. For example, in some aspects, a forward pass of the training procedure involves computing the weights Ŵ using Equation 1. In some aspects, Ŵ is in practice an activation of the network during training, rather than set of weights. That is, although Ŵ will become a set of weights after training and/or fusion, during QAT Ŵ may be treated as an activation and the quantization training system 105 may re-compute Ŵ each time).

In some aspects, as discussed above, Equation 1 contains multiple operations that are executed to compute Ŵ, and in some conventional approaches, each such operation has intermediate output (e.g., activation) that will be kept in memory during the forward pass. However, this can be problematic because the intermediate outputs may be substantially large, slowing or preventing the system from computing gradients for all such operations during the backward pass.

In some aspects, therefore, the quantization training system 105 uses checkpointing (e.g., gradient checkpointing) to avoid this memory overhead. Specifically, the quantization training system 105 may store only the input to a given layer or sequence of operations (e.g., the output of the previous layer, or some other input data such as the precomputed weights used in Equation 1), rather than the intermediate results of Equation 1. During the backward pass, the quantization training system 105 may re-execute a portion of the forward pass (e.g., using Equation 1) to re-generate these activations or other data.

In some aspects, to initialize the training, the parameters of the adapter model 145 may be set to any value. For example, in some aspects, some or all of the parameters are initialized randomly. In some aspects, A is initialized randomly, and B is initialized to have values of zero for all parameters. In some aspects, other approaches such as singular value decomposition (SVD)-based initialization may be used to initialize the adapter model 145.

In some aspects, after training, the parameters of the adapter model 145 (A and B) may be combined into a single matrix with the parameters of the base model 110, allowing these parameters to be effectively represented and used efficiently during inferencing. For example, in some aspects, after training, the aggregated model 125 may be defined using Equation 3 below, where W_{Z} (the parameters of the aggregated model 125) is a b-bit integer matrix that can be used to generate output during inferencing without introducing additional overhead.

$${W}_{ℤ} := clip ( round ( φ ( \frac{W}{{s}_{0}} ) + AB ) , - {2}^{b - 1} , {2}^{b - 1} - 1 ) \qquad ( 3 )$$

The aggregated model 125 can then be deployed for runtime use. As used herein, “deploying” the aggregated model 125 can generally include any operations used to prepare or provide the model for inferencing. For example, the quantization training system 105 may transmit the parameters of the aggregated model 125 to another system (e.g., a dedicated inferencing system) for use, or may instantiate the model locally fur inferencing (e.g., loading the parameters into memory). Although the illustrated example depicts the aggregated model 125 containing the base model 110 and the adapter model 145 as separate components for conceptual clarity, in some aspects, the base model 110 and adapter model 145 are merged or fused (e.g., using Equation 3) to generate the aggregated model 125. That is, the aggregated model 125 may include a single set of parameters (corresponding to both the base parameters and the adapter parameters), rather than discrete sets of parameters.

Advantageously, using the workflow 100, the quantization training system 105 can substantially improve existing solutions, allowing PTQ and QAT to be effectively combined to generate highly accurate aggregated models 125 in an efficient manner (e.g., with low compute overhead). This substantially improves both the training process (e.g., allowing training to be performed with less computational resources) as well as the inferencing process (e.g., allowing the model to be used with less overhead to generate more accurate results, as compared to some conventional approaches).

### Example Architecture for Quantization-Aware Training of Machine Learning Model Adapters

FIG. 2 depicts an example architecture 200 for quantization-aware training of machine learning model adapters, according to some aspects of the present disclosure. In some aspects, the architecture 200 is used by a quantization training system, such as the quantization training system 105 of FIG. 1. In some aspects, the architecture 200 depicts a portion of an aggregated model (e.g., the aggregated model 125 of FIG. 1).

In the illustrated example, the architecture 200 includes a layer 210 and an adapter 215. The layer 210 is generally representative of any layer, block, transformer, component, or other portion of a base machine learning model, such as the base model 110 of FIG. 1. In some aspects, the layer 210 includes one or more trained parameters (e.g., parameters having values learned during training of the base model 110). As discussed above, while training the adapter model(s), the parameters of the layer 210 may be frozen.

The adapter 215 is generally representative of a portion of an adapter model, such as the adapter model 145 of FIG. 1. Generally, each adapter 215 includes one or more trainable parameters. Each adapter 215 is configured to modify the data processed by and/or output by the base model. For example, in the illustrated architecture 200, the adapter 215 is arranged such that the feature tensor 205, which is used as input to the layer 210, is also used as input to the adapter 215. Further, the output of the layer 210 is aggregated with the output of the adapter 215 (via the operation 230). The resulting (aggregated) feature tensor 235 is then used as the output to the next component of the base model (e.g., the next layer and/or adapter). The operation 230 may generally include a variety of aggregation operations, including concatenation, element-wise summation or averaging, and the like.

In some aspects, each layer 210 (or other component) of the base model may have zero or more adapters 215. That is, some layers 210 may lack any adapters, some layers 210 may have a single corresponding adapter 215, and some layers 210 may have multiple adapters 215.

As illustrated, the adapter 215 generally includes two portions or components: a first portion 220 (labeled “A”) and a second portion 225 (labeled “B”). In some aspects, the portions 220 and 225 correspond to the parameters A and B discussed above with reference to Equation 1. In some aspects, as discussed above, the adapter 215 is a LoRA adapter. That is, the first portion 220 may include one or more layers or operations (e.g., linear layers) to map the input feature tensor 205 to a representation having a relatively lower rank or dimensionality (relative to the original rank of the feature tensor 205), and the second portion 225 may include one or more layers or operations (e.g., linear layers) to map the low-rank representation back to the original rank or dimensionality (allowing the output to be elementwise combined with the output of the layer 210).

In some aspects, as discussed above, the parameters of the adapter 215 are trained using QAT with knowledge or awareness of the quantization parameters and weights (e.g., the quantization scale s) of the base model (e.g., of the layer 210). For example, during the forward pass, the parameters of the adapter 215 may be mapped to the relevant integer grid (defined by the quantization parameters of the layer 210), ensuring that the values of these parameters is trained with awareness of the relevant quantization scheme. This can substantially improve performance of the combined model.

Further, as the parameters of the layer 210 may remain frozen during training of the adapter 215, the adapter 215 can generally be trained with substantially reduced computational complexity (e.g., resulting in less power consumption, less compute time, less memory usage, less heat generation, and the like). Additionally, in some aspects, the input to the adapter 215 may be checkpointed during training to further reduce the memory overhead of the QAT process. For example, during a given training iteration (which may involve one or more forward passes using the current parameters of the adapter 215, followed by a backward pass to generate updates to these current parameters), the quantization training system 105 may checkpoint (e.g., store or cache) the input (e.g., the feature tensor 205). During the backward pass, this cached version can be retrieved and used to compute updates to the model.

As discussed above, using the architecture 200, the quantization training system can substantially improve existing solutions, enabling efficient training of more accurate aggregated models.

### Example Architectures for Efficient Parameter Storage for Quantization-Aware Training

FIG. 3 depicts example architectures 305 for efficient parameter storage for quantization-aware training, according to some aspects of the present disclosure. In some aspects, the architectures 305 are used by a quantization training system, such as the quantization training system 105 of FIG. 1 and/or the quantization training system discussed above with reference to FIG. 2. In some aspects, the architectures 305 may be used to enable more efficient storage (e.g., in memory or a cache) of downcast parameters, such as the downcast parameters of a base model (e.g., the base model 110 of FIG. 1).

As discussed above, in some aspects, the quantization training system may use various downcasting operations to enable more efficient storage of the model parameters during training of the adapter model (e.g., using Equation 2, above). For example, the quantization training system may downcast the base model parameters from one bitwidth (e.g., sixteen or thirty-two bit floating point) to a second (smaller) bitwidth (e.g., 4-bit integer).

The illustrated example depicts two architectures 305A and 305B where model parameters (e.g., weights of the base model) encoded with a target bitwidth can be efficiently stored in a format or data structure having a larger bitwidth. Specifically, in the illustrated examples, the target bitwidth is four bits (e.g., INT4 encoding for the parameters) and the storage bitwidth is eight bits (e.g., an INT8 structure, or a single byte).

In the architecture 305A, the quantization training system may double pack parameters in the data structure. Specifically, as illustrated, the first portion 310 of the data structure (e.g., the four most significant bits (MSBs)) are used to store a first parameter, while the second portion 315 of the structure (e.g., the next four bits, or the four least significant bits (LSBs)) are used to store a second parameter. That is, in the illustrated example, the first four significant bits are used to store the four bits used to encode one parameter (denoted 1.1, 1.2, 1.3, and 1.4) while the least significant bits are used to store a second parameter (denoted 2.1 2.2, 2.3, and 2.4).

Advantageously, such double packing can substantially reduce the memory overhead of the system. Although the illustrated example depicts double packing two four-bit values precisely in an eight-bit structure, in some aspects, the quantization training system may pack any number of parameters in a single structure. For example, if the bitwidth of the data structure is at least twice the target bitwidth of the downcasting operation, the quantization training system may store at least two parameters in the structure. If the bitwidth of the data structure is at least three times the target bitwidth (e.g., if the target bitwidth is two bits, or the data structure is sixteen bits), the quantization training system can pack additional parameters into the same structure.

In the architecture 305B, the quantization training system may use the extra bits to pack parameters additional information about the parameter in the data structure. Specifically, as illustrated, the first portion 320 of the data structure (e.g., the four most significant bits) are used to store the encoded parameter (e.g., in INT4), while the second portion 325 of the structure (e.g., the next four bits, or the four least significant bits) are used to store the fractional portion of the parameter. That is, in the illustrated example, the first four significant bit are used to store the four bits used to encode a given parameter (denoted 1.1, 1.2, 1.3, and 1.4) while the least significant bits are used to store a representation of the fractional portion of the given parameter, which was removed during the rounding process of the downcasting operation (denoted f.1 f.2, f.3, and f.4).

Advantageously, such additional information can substantially improve the accuracy of the model after the training process. For example, if four bits are used to encode the fractional portion, the quantization training system can effectively represent additional precision during training using the remaining four bits. That is, two parameters may be rounded and/or clipped to the same integer (stored in INT4), but the remaining four bits allow for up to sixteen different alternative values for the same INT4 integer. This additional precision may be useful during training to improve the accuracy of the process. After training, the fractional information may no longer be needed, and the parameters may be encoded in the target bitwidth (potentially double packed, as discussed above).

Although the illustrated example depicts packing two four-bit values precisely in an eight-bit structure, in some aspects, the quantization training system may use any number of arrangements in a single structure. For example, if the target bitwidth is six, the quantization training system may use the remaining two bits to encode the fractional portion of the parameter.

### Example Method for Quantization-Aware Training of Model Adapters

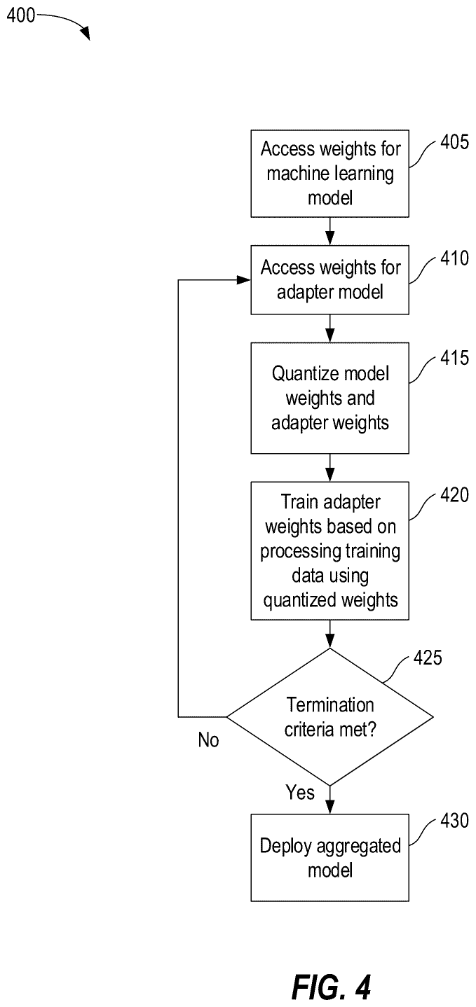

FIG. 4 is a flow diagram depicting an example method 400 for quantization-aware training of model adapters, according to some aspects of the present disclosure. In some aspects, the method 400 may be performed by a quantization training system, such as the quantization training system 105 of FIG. 1 and/or the quantization training system discussed above with reference to FIGS. 2-3.

At block 405, the quantization training system accesses weights (also referred to as parameters) for a machine learning model (e.g., the base model 110 of FIG. 1). In some aspects, as discussed above, the base machine learning model may be referred to as a pre-trained model to indicate that the values of the model were learned during a training phase and remain frozen, fixed, or otherwise unchanged during the method 400 (while training the adapter model(s). In some aspects, as discussed above, the quantization training system may further access quantization parameters (e.g., the quantization parameters 115 of FIG. 1) for the base model. For example, as discussed above, the quantization training system may determine the quantization scale of the base model. In some aspects, the weights of the base model are received in the quantized state. In other aspects, the weights of the base model may be accessed in full precision (e.g., thirty-two bit floating point).

At block 410, the quantization training system accesses the current weights for an adapter model. For example, for the first iteration of training, the quantization training system may access the initialized weights, as discussed above. For subsequent rounds of training, the quantization training system may access the current weights (e.g., the weights having values learned during one or more prior iterations).

At block 415, the quantization training system quantizes the adapter weights and the base model weights based on a desired or target bitwidth for the aggregated model. For example, as discussed above, the quantization training system may use Equation 1 to generate the quantized version of the weights.

At block 420, the quantization training system trains the weights of the adapter based on processing training data using the quantized weights. For example, as discussed above, the quantization training system may process a sample of training data (e.g., the training data 120 of FIG. 1) using the quantized model to generate an output, and the output may be compared against the label of the sample to generate a loss. In some aspects, this process is referred to as the forward pass. The quantization training system may then use the loss during a backward pass to compute gradients for the adapter weights.

In some aspects, as discussed above, the quantization training system may employ checkpointing to reduce the storage consumed during training (e.g., after the forward pass). For example, the quantization training system may cache the current inputs (used to generate Ŵ, as discussed above), which can then be used to re-compute the weights during the backward pass. These quantized weights are used to generate the gradients, which are used to update the adapter parameters.

At block 425, the quantization training system determines whether one or more training termination criteria are met. Generally, the particular adapter training termination criteria may vary depending on the particular implementation. For example, in some aspects, the quantization training system may determine whether a defined number of training iterations or epochs have been applied, whether a defined amount of computing resources have been spent, whether a defined length of time has passed, whether the model accuracy has reached a desired level, and the like.

If the termination criteria are not met, the method 400 returns to block 410, where the quantization training system can access the updated adapter weights to begin a new iteration or round of training. If, at block 425, the quantization training system determines that the termination criteria are satisfied, the method 400 continues to block 430, where the quantization training system deploys the aggregated model (e.g., the aggregated model 125 of FIG. 1). As discussed above, deploying the aggregated model may include a variety of operations, and generally refers to any operations used to prepare or provide the model for runtime use (e.g., inferencing) to generate output. For example, the quantization training system may generate a data structure containing the learned parameters, transmit the model to one or more other systems for runtime use, instantiate the model locally (e.g., load the model into memory to be used), and the like.

Although not depicted in the illustrated example, in some aspects, the quantization training system may merge or fuse the parameters of the aggregated model prior to deploying the model. For example, as discussed above, the quantization training system may use Equation 3 to aggregate the parameters of the base model and the adapter model, enabling a single model (e.g., a single set of parameters) to be deployed for inferencing.

### Example Method for Quantizing Model Parameters for Quantization-Aware Training

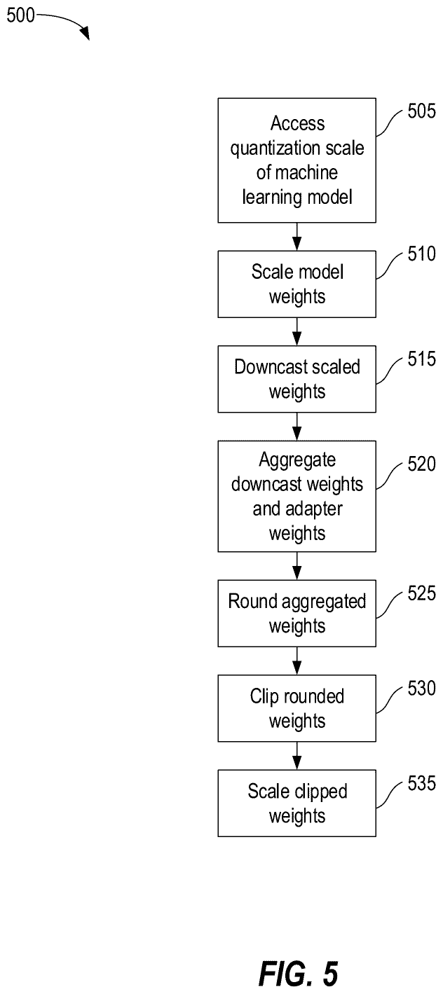

FIG. 5 is a flow diagram depicting an example method 500 for quantizing model parameters for quantization-aware training, according to some aspects of the present disclosure. In some aspects, the method 500 may be performed by a quantization training system, such as the quantization training system 105 of FIG. 1 and/or the quantization training system discussed above with reference to FIGS. 2-4. In some aspects, the method 500 provides additional detail for block 415 of FIG. 4.

At block 505, the quantization training system accesses a quantization scale of the base machine learning model (e.g., so in Equation 1). As discussed above, the quantization scale may be a value determined (e.g., using PTQ) for the base model based on a target quantized bitwidth for the model. In some aspects, the quantization scale is determined by the computing system that trained and/or quantized the base model.

At block 510, the quantization training system scales the weights of the base model (e.g., W in Equation 1) based on the quantization scale. For example, as discussed above with reference to Equation 1, the quantization training system may compute

$$\frac{W}{{s}_{0}} .$$

At block 515, the quantization training system downcasts the scaled base model weights. As discussed above, this downcasting operation may generally include any variety of operations used to reduce the bitwidth of the scaled base model parameters. For example, as discussed above with reference to Equations 1 and 2, the quantization training system may compute

$$φ ( \frac{W}{{s}_{0}} ) .$$

In some aspects, as discussed above, these downcast weights may be frozen during training of the adapter model. In some aspects, therefore, the quantization training system may compute the downcast weights once (e.g., at the start of training), store the parameters (e.g., in a data structure such as discussed above with reference to FIG. 3), and re-use these stored parameters for the training process without re-computing the downcast parameters each iteration.

At block 520, the quantization training system aggregates the downcast weights with the adapter weights (e.g., A and B). In some aspects, as discussed above, this aggregation may include summation, concatenation, and the like.

At block 525, the quantization training system aggregates the rounds the aggregated weights. For example, as discussed above with reference to Equation 1, the quantization training system may round each weight of the aggregated weights to the nearest integer.

At block 530, the quantization training system clips the rounded weights based on the determined target bitwidth (e.g., based on the quantization range provided by the bitwidth). For example, as discussed above, for a target bitwidth b, the quantization training system may clip the rounded weights to the range [−2^{b-1}, 2^{b-1}−1]. In some aspects, to clip the weights, any parameters having a value within the (inclusive) range are left unchanged, while values outside of the range are clipped to the minimum or maximum of the range (depending on whether the value is above or below the range). In some aspects, as discussed above, the clipped and rounded weights therefore include a set of integer values within the defined range.

At block 535, the quantization training system optionally scales the clipped weights based on a second quantization scale (e.g., s in Equation 1). As discussed above, this second scale may be fixed (e.g., static) during training of the adapter, or may be learnable during training. In some aspects, this second quantization scale may be used during training, but may be unused during inferencing. In other aspects, the second quantization scale may be used during inferencing, as discussed above.

### Example Method for Quantization-Aware Training

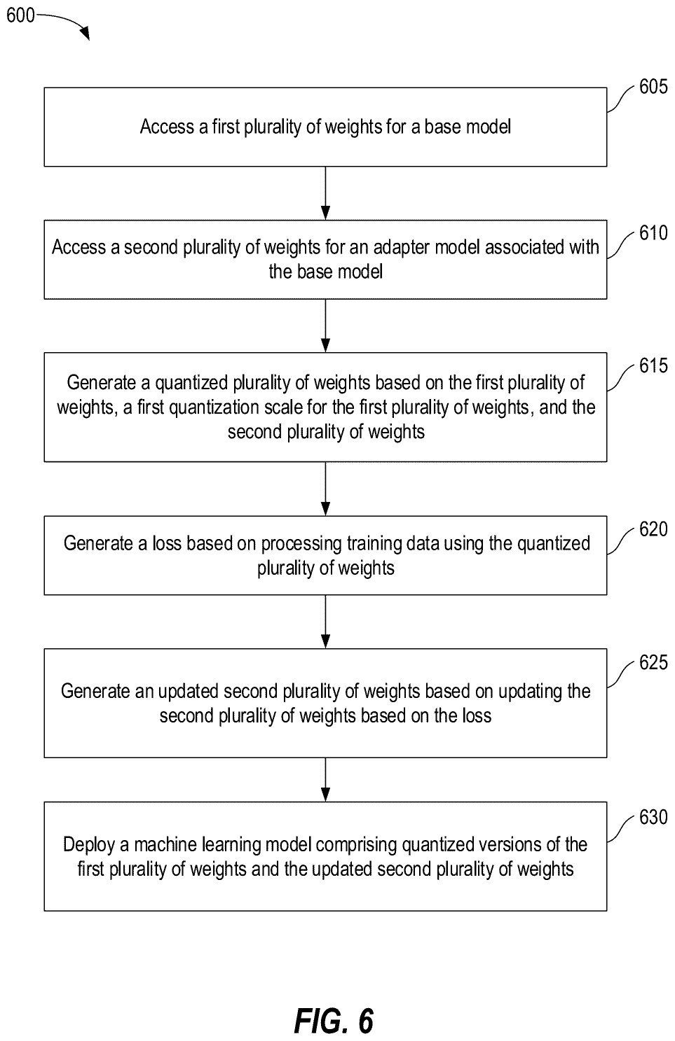

FIG. 6 is a flow diagram depicting an example method 600 for quantization-aware training, according to some aspects of the present disclosure. In some aspects, the method 600 may be performed by a quantization training system, such as the quantization training system 105 of FIG. 1 and/or the quantization training system discussed above with reference to FIGS. 2-5.

At block 605, a first plurality of weights for a base model is accessed.

At block 610, a second plurality of weights for an adapter model associated with the base model is accessed.

At block 615, a quantized plurality of weights is generated based on the first plurality of weights, a first quantization scale for the first plurality of weights, and the second plurality of weights.

At block 620, a loss is generated based on processing training data using the quantized plurality of weights.

At block 625, an updated second plurality of weights is generated based on updating the second plurality of weights based on the loss.

At block 630, a machine learning model comprising quantized versions of the first plurality of weights and the updated second plurality of weights is deployed.

In some aspects, the first plurality of weights and the first quantization scale are static when the updated second plurality of weights is generated.

In some aspects, generating the quantized plurality of weights includes generating a scaled plurality of weights based on applying the first quantization scale to the first plurality of weights, generating an aggregated plurality of weights based on the scaled plurality of weights and the second plurality of weights, and generating the quantized plurality of weights based on rounding and clipping the aggregated plurality of weights.

In some aspects, the method 600 further includes generating a downcast plurality of weights based on the first plurality of weights, wherein the downcast plurality of weights is re-used while training the adapter model, and generating the quantized plurality of weights based on the downcast plurality of weights.

In some aspects, generating the downcast plurality of weights comprises reducing a bitwidth used to store the downcast plurality of weights, as compared to a bitwidth used to store the first plurality of weights.

In some aspects, generating the downcast plurality of weights includes converting each of the first plurality of weights to an integer format having a target bitwidth for the quantized plurality of weights and storing the converted first plurality of weights using one or more data structures having at least double the target bitwidth.

In some aspects, generating the downcast plurality of weights comprises converting each of the first plurality of weights to an integer format having a target bitwidth for the quantized plurality of weights, and, for each respective weight of the converted first plurality of weights, storing the respective weight using a first portion of a data structure having a greater bitwidth than the target bitwidth and storing a respective fractional portion of the respective weight using a second portion of the data structure.

In some aspects, the quantized plurality of weights are further generated based on a second quantization scale.

In some aspects, the method 600 further includes generating an updated value for the second quantization scale based on the loss.

In some aspects, the method 600 further includes, during training of the second plurality of weights, checkpointing at least one intermediate value used to generate the quantized plurality of weights during a forward pass of the training and re-generating the quantized plurality of weights during a corresponding backward pass based on the checkpointed at least one intermediate value.

### Example Processing System for Machine Learning

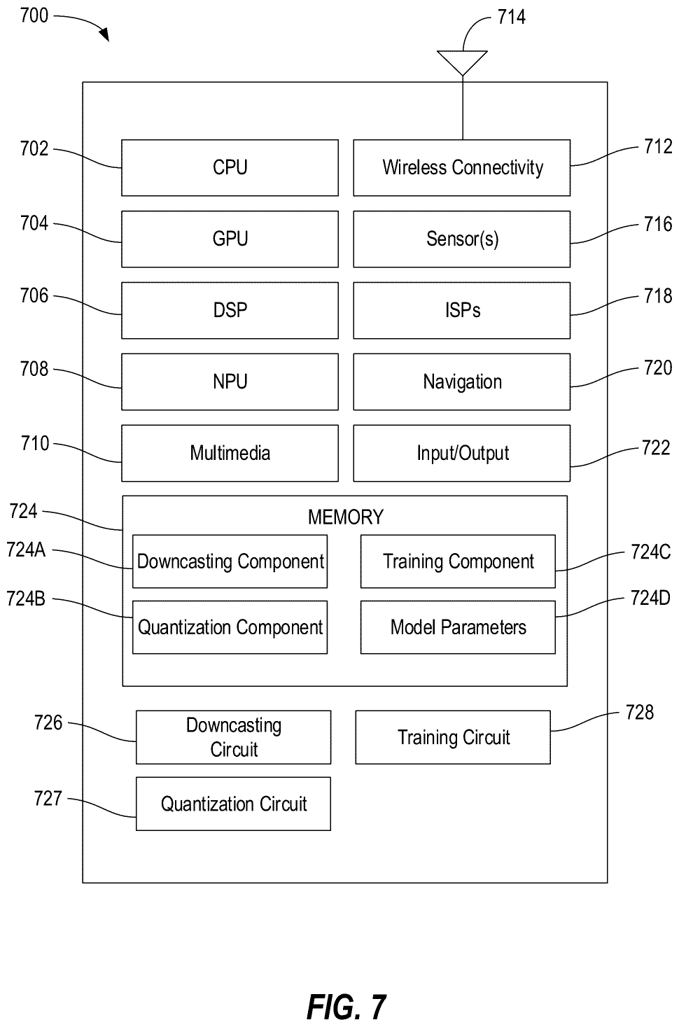

FIG. 7 depicts an example processing system 700 configured to perform various aspects of the present disclosure, including, for example, the techniques and methods described with respect to FIGS. 1-6. In some aspects, the processing system 700 may correspond to a quantization training system. For example, the processing system 700 may correspond to the quantization training system discussed above with reference to FIGS. 1-6. Although depicted as a single system for conceptual clarity, in some aspects, as discussed above, the components described below with respect to the processing system 700 may be distributed across any number of devices or systems.

The processing system 700 includes a central processing unit (CPU) 702, which in some examples may be a multi-core CPU. Instructions executed at the CPU 702 may be loaded, for example, from a program memory associated with the CPU 702 or may be loaded from a memory partition (e.g., a partition of a memory 724).

The processing system 700 also includes additional processing components tailored to specific functions, such as a graphics processing unit (GPU) 704, a digital signal processor (DSP) 706, a neural processing unit (NPU) 708, a multimedia component 710 (e.g., a multimedia processing unit), and a wireless connectivity component 712.

An NPU, such as the NPU 708, is generally a specialized circuit configured for implementing the control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 708, are configured to accelerate the performance of common machine learning tasks, such as image classification, machine translation, object detection, and various other predictive models. In some examples, a plurality of NPUs may be instantiated on a single chip, such as a system on a chip (SoC), while in other examples the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this piece of data through an already trained model to generate a model output (e.g., an inference).

In some implementations, the NPU 708 is a part of one or more of the CPU 702, the GPU 704, and/or the DSP 706.

In some examples, the wireless connectivity component 712 may include subcomponents, for example, for third generation (3G) connectivity, fourth generation (4G) connectivity (e.g., Long-Term Evolution (LTE)), fifth generation (5G) connectivity (e.g., New Radio (NR)), Wi-Fi connectivity, Bluetooth connectivity, and other wireless data transmission standards. The wireless connectivity component 712 is further coupled to one or more antennas 714.

The processing system 700 may also include one or more sensor processing units 716 associated with any manner of sensor, one or more image signal processors (ISPs) 718 associated with any manner of image sensor, and/or a navigation processor 720, which may include satellite-based positioning system components (e.g., GPS or GLONASS) as well as inertial positioning system components.

The processing system 700 may also include one or more input and/or output devices 722, such as screens, touch-sensitive surfaces (including touch-sensitive displays), physical buttons, speakers, microphones, and the like.

In some examples, one or more of the processors of the processing system 700 may be based on an ARM or RISC-V instruction set.

The processing system 700 also includes a memory 724, which is representative of one or more static and/or dynamic memories, such as a dynamic random access memory, a flash-based static memory, and the like. In this example, the memory 724 includes computer-executable components, which may be executed by one or more of the aforementioned processors of the processing system 700.

In particular, in this example, the memory 724 includes a downcasting component 724A, a quantization component 724B, and a training component 724C. Although not depicted in the illustrated example, the memory 724 may also include other components, such as an inferencing or generation component to manage the generation of output data using trained machine learning models, and the like. Though depicted as discrete components for conceptual clarity in FIG. 7, the illustrated components (and others not depicted) may be collectively or individually implemented in various aspects.

As illustrated, the memory 724 also includes a set of model parameters 724D (e.g., parameters of one or more machine learning models, such as weights and/or biases, used to generate model output). For example, as discussed above, the model parameters 724D may include pre-trained parameters for a base model, learned parameters for one or more adapters, and the like. Although not depicted in the illustrated example, the memory 724 may also include other data such as training data.

The processing system 700 further comprises a downcasting circuit 726, a quantization circuit 727, and a training circuit 728. The depicted circuits, and others not depicted (such as an inferencing circuit), may be configured to perform various aspects of the techniques described herein.

The downcasting component 724A and/or the downcasting circuit 726 (which may correspond to the downcasting component 130 of FIG. 1) may be used to downcast parameters of the base model to improve training efficiency, as discussed above. For example, the downcasting component 724A and/or the downcasting circuit 726 may downcast parameters to smaller bitwidths to enable the downcast parameters to be stored or cached with less memory overhead. In some aspects, as discussed above, the downcast parameters are stored in efficient data structures such as double packed into an INT8 structure, stored with additional information indicating fractional values from the parameters, and the like.

The quantization component 724B and/or the quantization circuit 727 (which may correspond to the quantization component 135 of FIG. 1) may be used to quantize the model parameters (e.g., the base model parameters and the adapter model parameters) during training and/or inference, as discussed above. For example, the quantization component 724B and/or the quantization circuit 727 may Equation 1 to quantize the parameters, enabling QAT to be performed.

The training component 724C and/or the training circuit 728 (which may correspond to the training component 140 of FIG. 1) may be used to update the parameters of the adapter models during QAT, as discussed above. For example, the training component 724C and/or the training circuit 728 may process data during the forward pass to generate output, checkpoint layer input(s) during the forward pass, compute losses based on the model output, and generate updates to the adapter based on the checkpointed data.

Though depicted as separate components and circuits for clarity in FIG. 7, the downcasting circuit 726, the quantization circuit 727, and the training circuit 728 may collectively or individually be implemented in other processing devices of the processing system 700, such as within the CPU 702, the GPU 704, the DSP 706, the NPU 708, and the like.

Generally, the processing system 700 and/or components thereof may be configured to perform the methods described herein.

Notably, in other aspects, aspects of the processing system 700 may be omitted, such as where the processing system 700 is a server computer or the like. For example, the multimedia component 710, the wireless connectivity component 712, the sensor processing units 716, the ISPs 718, and/or the navigation processor 720 may be omitted in other aspects. Further, aspects of the processing system 700 may be distributed between multiple devices.

### Example Clauses

Implementation examples are described in the following numbered clauses:

Clause 1: A method, comprising: accessing a first plurality of weights for a base model; accessing a second plurality of weights for an adapter model associated with the base model; generating a quantized plurality of weights based on the first plurality of weights, a first quantization scale for the first plurality of weights, and the second plurality of weights; generating a loss based on processing training data using the quantized plurality of weights; generating an updated second plurality of weights based on updating the second plurality of weights based on the loss; and deploying a machine learning model comprising quantized versions of the first plurality of weights and the updated second plurality of weights.

Clause 2: A method according to Clause 1, wherein the first plurality of weights and the first quantization scale are static when the updated second plurality of weights is generated.

Clause 3: A method according to any of Clauses 1-2, wherein generating the quantized plurality of weights comprises: generating a scaled plurality of weights based on applying the first quantization scale to the first plurality of weights; generating an aggregated plurality of weights based on the scaled plurality of weights and the second plurality of weights; and generating the quantized plurality of weights based on rounding and clipping the aggregated plurality of weights.

Clause 4: A method according to any of Clauses 1-3, further comprising: generating a downcast plurality of weights based on the first plurality of weights, wherein the downcast plurality of weights is re-used while training the adapter model; and generating the quantized plurality of weights based on the downcast plurality of weights.

Clause 5: A method according to Clause 4, wherein generating the downcast plurality of weights comprises reducing a bitwidth used to store the downcast plurality of weights, as compared to a bitwidth used to store the first plurality of weights.

Clause 6: A method according to any of Clauses 4-5, wherein generating the downcast plurality of weights comprises: converting each of the first plurality of weights to an integer format having a target bitwidth for the quantized plurality of weights; and storing the converted first plurality of weights using one or more data structures having at least double the target bitwidth.

Clause 7: A method according to any of Clauses 4-6, wherein generating the downcast plurality of weights comprises: converting each of the first plurality of weights to an integer format having a target bitwidth for the quantized plurality of weights; and for each respective weight of the converted first plurality of weights: storing the respective weight using a first portion of a data structure having a greater bitwidth than the target bitwidth; and storing a respective fractional portion of the respective weight using a second portion of the data structure.

Clause 8: A method according to any of Clauses 1-7, wherein the quantized plurality of weights are further generated based on a second quantization scale.

Clause 9: A method according to Clause 8, further comprising generating an updated value for the second quantization scale based on the loss.

Clause 10: A method according to any of Clauses 1-9, further comprising, during training of the second plurality of weights: checkpointing at least one intermediate value used to generate the quantized plurality of weights during a forward pass of the training; and re-generating the quantized plurality of weights during a corresponding backward pass based on the checkpointed at least one intermediate value.

Clause 11: A processing system comprising: a memory comprising computer-executable instructions; and one or more processors configured to execute the computer-executable instructions and cause the processing system to perform a method in accordance with any of Clauses 1-10.

Clause 12: A processing system comprising means for performing a method in accordance with any of Clauses 1-10.

Clause 13: A non-transitory computer-readable medium comprising computer-executable instructions that, when executed by one or more processors of a processing system, cause the processing system to perform a method in accordance with any of Clauses 1-10.

Clause 14: A computer program product embodied on a computer-readable storage medium comprising code for performing a method in accordance with any of Clauses 1-10.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processing system comprising:
one or more memories comprising processor-executable instructions; and
one or more processors configured to execute the processor-executable instructions and cause the processing system to:
access a first plurality of weights for a base model;
access a second plurality of weights for an adapter model associated with the base model;
generate a quantized plurality of weights based on the first plurality of weights, a first quantization scale for the first plurality of weights, and the second plurality of weights;
generate a loss based on processing training data using the quantized plurality of weights;
generate an updated second plurality of weights based on updating the second plurality of weights based on the loss; and
deploy a machine learning model comprising quantized versions of the first plurality of weights and the updated second plurality of weights.

2. The processing system of claim 1, wherein the first plurality of weights and the first quantization scale are static when the updated second plurality of weights is generated.

3. The processing system of claim 1, wherein, to generate the quantized plurality of weights, the one or more processors are configured to further execute the processor-executable instructions and cause the processing system to:
generate a scaled plurality of weights based on applying the first quantization scale to the first plurality of weights;
generate an aggregated plurality of weights based on the scaled plurality of weights and the second plurality of weights; and
generate the quantized plurality of weights based on rounding and clipping the aggregated plurality of weights.

4. The processing system of claim 1, wherein the one or more processors are configured to further execute the processor-executable instructions and cause the processing system to:
generate a downcast plurality of weights based on the first plurality of weights, wherein the downcast plurality of weights is re-used while training the adapter model; and
generate the quantized plurality of weights based on the downcast plurality of weights.

5. The processing system of claim 4, wherein, to generate the downcast plurality of weights, the one or more processors are configured to further execute the processor-executable instructions and cause the processing system to reduce a bitwidth used to store the downcast plurality of weights, as compared to a bitwidth used to store the first plurality of weights.

6. The processing system of claim 4, wherein, to generate the downcast plurality of weights, the one or more processors are configured to further execute the processor-executable instructions and cause the processing system to:
convert each of the first plurality of weights to an integer format having a target bitwidth for the quantized plurality of weights; and
store the converted first plurality of weights using one or more data structures having at least double the target bitwidth.

7. The processing system of claim 4, wherein, to generate the downcast plurality of weights, the one or more processors are configured to further execute the processor-executable instructions and cause the processing system to:
convert each of the first plurality of weights to an integer format having a target bitwidth for the quantized plurality of weights; and
for each respective weight of the converted first plurality of weights:
store the respective weight using a first portion of a data structure having a greater bitwidth than the target bitwidth; and
store a respective fractional portion of the respective weight using a second portion of the data structure.

8. The processing system of claim 1, wherein the one or more processors are configured to further execute the processor-executable instructions and cause the processing system to generate the quantized plurality of weights based further on a second quantization scale.

9. The processing system of claim 8, wherein the one or more processors are configured to further execute the processor-executable instructions and cause the processing system to generate an updated value for the second quantization scale based on the loss.

10. The processing system of claim 1, wherein the one or more processors are configured to further execute the processor-executable instructions and cause the processing system to, during training of the second plurality of weights:
checkpoint at least one intermediate value used to generate the quantized plurality of weights during a forward pass of the training; and
re-generate the quantized plurality of weights during a corresponding backward pass based on the checkpointed at least one intermediate value.

11. A processor-implemented method for training machine learning models, comprising:
accessing a first plurality of weights for a base model;
accessing a second plurality of weights for an adapter model associated with the base model;
generating a quantized plurality of weights based on the first plurality of weights, a first quantization scale for the first plurality of weights, and the second plurality of weights;
generating a loss based on processing training data using the quantized plurality of weights;
generating an updated second plurality of weights based on updating the second plurality of weights based on the loss; and
deploying a machine learning model comprising quantized versions of the first plurality of weights and the updated second plurality of weights.

12. The processor-implemented method of claim 11, wherein the first plurality of weights and the first quantization scale are static when the updated second plurality of weights is generated.

13. The processor-implemented method of claim 11, wherein generating the quantized plurality of weights comprises:
generating a scaled plurality of weights based on applying the first quantization scale to the first plurality of weights;
generating an aggregated plurality of weights based on the scaled plurality of weights and the second plurality of weights; and
generating the quantized plurality of weights based on rounding and clipping the aggregated plurality of weights.

14. The processor-implemented method of claim 11, further comprising:
generating a downcast plurality of weights based on the first plurality of weights, wherein the downcast plurality of weights is re-used while training the adapter model; and
generating the quantized plurality of weights based on the downcast plurality of weights.

15. The processor-implemented method of claim 14, wherein generating the downcast plurality of weights comprises reducing a bitwidth used to store the downcast plurality of weights, as compared to a bitwidth used to store the first plurality of weights.

16. The processor-implemented method of claim 14, wherein generating the downcast plurality of weights comprises:
converting each of the first plurality of weights to an integer format having a target bitwidth for the quantized plurality of weights; and
storing the converted first plurality of weights using one or more data structures having at least double the target bitwidth.

17. The processor-implemented method of claim 14, wherein generating the downcast plurality of weights comprises:
converting each of the first plurality of weights to an integer format having a target bitwidth for the quantized plurality of weights; and
for each respective weight of the converted first plurality of weights:
storing the respective weight using a first portion of a data structure having a greater bitwidth than the target bitwidth; and
storing a respective fractional portion of the respective weight using a second portion of the data structure.

18. The processor-implemented method of claim 11, wherein the quantized plurality of weights are further generated based on a second quantization scale.

19. The processor-implemented method of claim 18, further comprising generating an updated value for the second quantization scale based on the loss.

20. The processor-implemented method of claim 11, further comprising, during training of the second plurality of weights:
checkpointing at least one intermediate value used to generate the quantized plurality of weights during a forward pass of the training; and
re-generating the quantized plurality of weights during a corresponding backward pass based on the checkpointed at least one intermediate value.
